(19) United States
(12) Patent Application Publication
(10) Pub. No.: US 2004/0101237 A1
(43) Pub. Date: May 27, 2004

(54) Method and apparatus for providing tunable chromatic dispersion slope compensation

(76) Inventor: Xiang-Dong Cao, Boca Raton, FL (US)

Correspondence Address: Xiang-Dong Cao, 8790 Twin Lake Drive, Boca Raton, FL, 33496, US

(21) Appl. No.: 10/305,336

(22) Filed: Nov. 26, 2002

(51) Int. Cl. G02B 6/26; G02B 6/34

(52) U.S. Cl. 385/27; 385/37

(57) ABSTRACT

A tunable high-order chromatic dispersion compensation arrangement compensates for dispersion slope in an optical signal transmitted in optical fibers. A pair of parallel diffractive gratings is used to disperse wavelength channels into separate but parallel beams, a novel dispersive element based-on all-optical all-pass filter technology is used to apply required dispersion to different wavelength channels. A novel beam imaging arrangement based on diffractive grating is used to modify the beam width across the dispersive element such that dispersion slope or wavelength-dependent dispersion can be adjusted. Since the tuning mechanism is independent of material properties such as dispersion characteristics of the dispersive element, the resulting tunable dispersion slope compensator is highly reliable to manufacturing tolerance, environmental degradations, and can be massively produced.

### CROSS REFERENCE TO RELATED APPLICATIONS

Not applicable

### STATEMENT REGARDING FEDERALLY SPONSORED RESEARCH AND DEVELOPMENT

Not applicable

### REFERENCE TO SEQUENCE LISTING, A TABLE OR A COMPUTER PROGRAMM LISTING COMPACT DISK APPENDIX

Not applicable

### BACKGROUND OF THE INVENTION

The present invention relates to method and apparatus for providing tunable high-order chromatic dispersion compensation in high-speed optical transmission networks and systems.

Chromatic dispersion of optical fibers is one of the most limiting factors for high-speed optical communication systems. For example, it limits the transmission distance of directly modulated lasers to a few tens of kilometers in conventional single mode fibers (G.652) at bit rate of 10 Gbit/s. Expensive external modulators have to be used to increase the reach since external modulators have small frequency chirp. In the backbone long-haul networks where dense wavelength division multiplexing (DWDM) systems are widely used, expensive temperature-cooled distributed feedback lasers (DFBs) and Lithium Niobate Mach-Zender modulators have to be used. This gives rise to not only higher system cost, but also higher power consumption and bigger sizes.

Different types of optical fibers have different dispersion characteristics. Dispersion and dispersion slope, or the wavelength dependent dispersion, are the most important fiber characteristics. In high capacity DWDM systems, it is essential to compensate for both the dispersion and the dispersion slope. Due to the large variation of fiber types, fiber characteristics, and even fiber length in the existing optical networks, it is desirable to have tunable dispersion compensation devices that compensate for not only dispersion but also dispersion slope.

Dispersion compensating fibers (DCFs) are considered one of the most reliable techniques for compensating for both dispersion and dispersion slope for the single mode fibers. Although DCFs have enabled system designers to increase system reach and total bandwidth or number of channels, there still are many drawbacks. DCFs have following typical undesirable features such as high insertion loss, high optical nonlinearity, large size and high cost. For practical applications, the fiber span lengths in a network are not known beforehand, and fiber dispersion values vary from fiber to fiber. Therefore it is difficult to use DCF to accurately compensate for the fiber dispersion. Ideally, fiber Bragg gratings (FBG) are preferable over DCFs for several attractive reasons such as, virtually no optical nonlinearity, low insertion loss, compact size, and flexibility for different fiber types. However, a group-delay ripple associated with an FBG makes it inferior in most applications when compared to a DCF. FBG based dispersion compensators are normally narrow band, they can be used to compensate for dispersion for one or a few channels. Other techniques such as high-order mode fibers and virtual phase arrays can also be used. Although high-order mode fibers have significantly less optical nonlinearities, they suffer from problems of multi-path interference due to finite mode conversion ratios. High-order mode fibers also have other drawbacks similar to DCFs in terms of tunability. It is important to provide a dispersion compensation mechanism which (a) compensates for dispersion and dispersion slope, (b) is cost effective low cost, (c) has a compact size and no moving parts.

### BRIEF SUMMARY OF THE INVENTION

The present invention is directed to method and apparatus for providing tunable high-order chromatic dispersion compensation using a novel technique based on diffractive gratings and all-path filters. Compared to prior art, the present invention has the advantages of (a) low cost, (b) compact size, (c) no optical nonlinearity, (d) low insertion loss. Viewed from one aspect, the present invention is directed to an optical arrangement for providing tunable dispersion slope compensation to a received dispersion distorted input signal comprising N wavelength multiplexed channels. The optical arrangement comprises a pair of diffractive gratings, a quarter wave-plate, a dispersive element, a collimator, an actuator or a translation stage and a circulator. The output optical signal experiences a certain amount dispersion slope, defined as wavelength-dependent dispersion, which is tunable by moving the second grating. The second grating is mounted on an actuator so that the second grating can be translated remaining parallel to the first grating.

### BRIEF DESCRIPTION OF THE SEVERAL VIEWS OF THE DRAWING

FIG. 1 is a block diagram of a tunable dispersion slope compensating arrangement in accordance with a first embodiment of the present invention.

FIG. 2 graphically shows the design of the dispersive element used in the arrangement FIG. 1.

FIG. 3 graphically further illustrates the moving mechanism of the second grating 27 in arrangement FIG. 1, which is required for tuning the total dispersion slope.

FIG. 4 graphically shows exemplary tuning range of total dispersion slope of the arrangement FIG. 1.

FIG. 5 is a block diagram of a tunable dispersion slope compensating arrangement in accordance with a second embodiment of the present invention.

The drawings are not necessarily to scale.

### DETAILED DESCRIPTION OF THE INVENTION

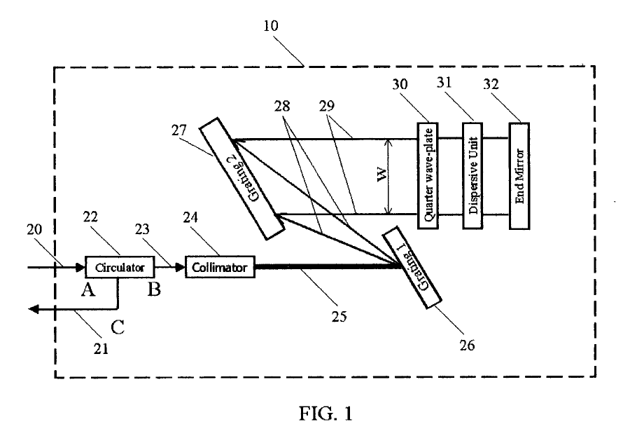

Referring now to FIG. 1, there is shown a block diagram of a tunable optical dispersion slope compensating arrangement 10 (shown within a dashed line rectangle) in accordance with a first embodiment of the present invention. The dispersion slope compensating arrangement 10 comprises an optical circulator 22, a collimator 24, two optical gratings 26 and 27, a quarter-wave plate 30, a dispersive element 31 and a back mirror 32. The optical circulator 22 is shown as comprising three ports A, B, and C. The circulator 22 is serially coupled to the collimator 24 along an optical fiber 23, which is coupled at one end to Port B of the optical circulator 22 and another end to input port of collimator 24. An optical input fiber 20 and an optical output fiber 21 are coupled at one end thereof to ports A and C, respectively, of the optical circulator 22. The output of the collimator 24 is a collimated optical beam 25 in free space, which is aligned to the first grating 26. Grating 26 and 27 are parallel to each other. The diffracted optical beam from grating 26 propagates towards to the second grating 27, which further diffracts the incoming beam 28 to an optical beam 29 that is parallel to beam 25. A quarter-wave plate 30, a dispersive element 31 and an end mirror are serially placed in the path of beam 29. The end mirror 31 is positioned in such a way that it is perpendicular to the input optical beam and the reflected beam propagates back to the exactly the same direction as the input beam.

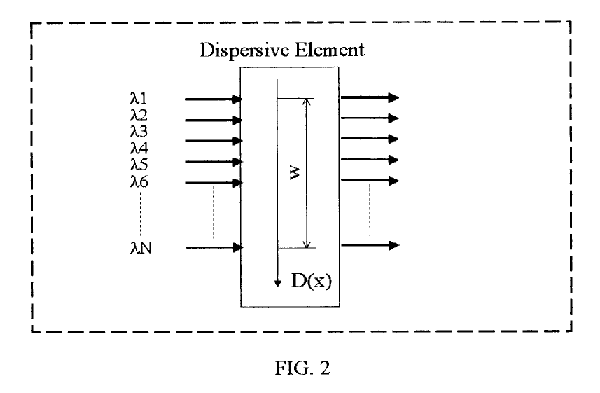

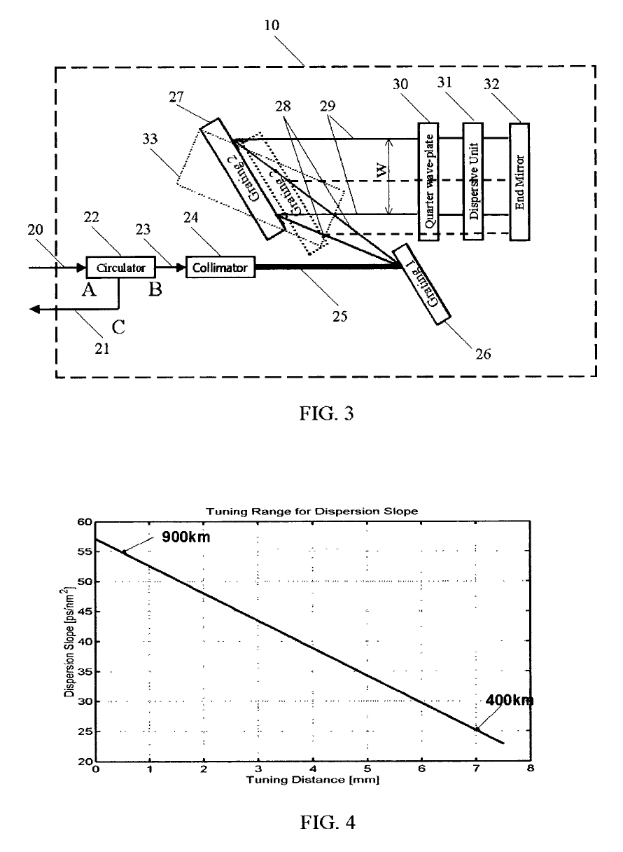

In operation, a dispersion distorted optical input signal is received by the tunable optical dispersion slope compensating arrangement 10 via the optical input fiber 20, and is coupled to Port A of the optical circulator 22. The optical input signal comprises N wavelength multiplexed channels. The optical circulator 22 directs the optical input signal to port B, which directs the optical input signal onto optical fiber 23. The collimator 24 couples the optical signal from fiber 23 and collimates the output beam to a pre-determined beam width. The collimated beam 25 from the collimator 24 propagates onto the first grating 26 and is spatially dispersed into beam 28. The second grating 27 is placed parallel to grating 26, it intersects the incoming beam 28, and diffracts into a collimated beam 29. The cross-section of beam 29 is elliptical. As a result of the mentioned double diffraction, the N wavelength-multiplexed signal is spatially demultiplexed in such a way that lower wavelength channels are placed at the top of beam 29, while higher wavelength channels are placed at the bottom of the beam 29. The quarter wave-plate 30 is placed in such a way that the reflected beam has its polarization rotated 90 degrees after the second pass so that the polarization dependence of the optical setup, especially the gratings can be eliminated. The dispersive element 31 gives rise to a certain amount of dispersion upon transmission, and there is a variation in dispersion values depending upon the physical location across the beam. The end mirror 32 with its surface perpendicular to the input beam reflects the incoming beam back. The reflected beam will propagate back along the exact same path as the input beam, and is redirected to output PORT C of the circulator 22. The output surface of the dispersive element 31 in FIG. 1 can be coated as a mirror so that input beam can be reflected back so that the external mirror 32 is not necessary. The grating 27 is attached to a translation stage or actuator 33 (see FIG. 3 for details) in such a way that the grating 27 can be moved remaining parallel to the first grating. The beam width of optical beam 29 can be adjusted by moving actuator 33, which changes the total dispersion slope of the input optical signal as explained in FIG. 2 and FIG. 3.

Referring to FIG. 2, the functional diagram of the dispersive element 31 in FIG. 1. The input beam consists of N spatially separated beam lets with their wavelengths ordered across X direction. After propagating through the dispersive element, each beam let experiences different amount dispersion D(x) depending on its position x along the X axis as shown in FIG. 2.

If D(x) changes linearly to distance x, then dispersion slope can be written as:

S=dD/dλ=Sₓdx/dλ (1)

Where D(x)=D₀+Sₓx, D₀ is dispersion at x=0, Sₓ is the rate of dispersion change along x. Therefore, an incoming optical signal with a given number of wavelength channels (N) or optical bandwidth (OBW), will experience a dispersion difference among all channels equal to:

S=Sₓw/OBW (2)

Where, w is the total beam width as shown in FIG. 1 and FIG. 2, and OBW=N*channel spacing is the total optical bandwidth of the input optical signal. There are two ways to tune the added dispersion slope to the input optical signal, one is to tune the dispersive element in such a way that Sₓ is tuned, the second method is to change the beam w while keep Sₓ fixed, as indicated from Eq.(2). The beam width w can be easily changed by moving the second grating 27 as shown in FIG. 1 This is a preferred method since the physical properties of the dispersive element is not changed, the tenability is achieved by changing the geometry of the optical beam, which is more stable and easier to accomplish in practice.

Referring now to FIG. 3, the beam width can be easily changed by moving the second grating. The solid lines represents one position, while the dashed lines shows the new position as well as the new beam width. A translation stage or any other actuator 33 can be used to move the second grating while keeping the grating in parallel to the first grating. The grating 27 is attached to the actuator 33, which is not shown in FIG. 1. The new beam width is shown in dashed lines in FIG. 3.

Referring now to FIG. 4, the total dispersion slope for an input optical signal with a 35 nm bandwidth (1530 nm to 1565 nm), and a total dispersion slope of 400-900 km conventional single mode fibers, can be compensated for by moving the second grating about 7 mm. The flexibility of the design of the tunable optical dispersion slope compensating arrangement 10 makes it possible to compensate for a variety of fiber types. In this example, Sₓ=80 ps/nm/mm, beam width=10-25 mm. The total tuning range depends on the distance between the gratings and the angular dispersion of the first grating.

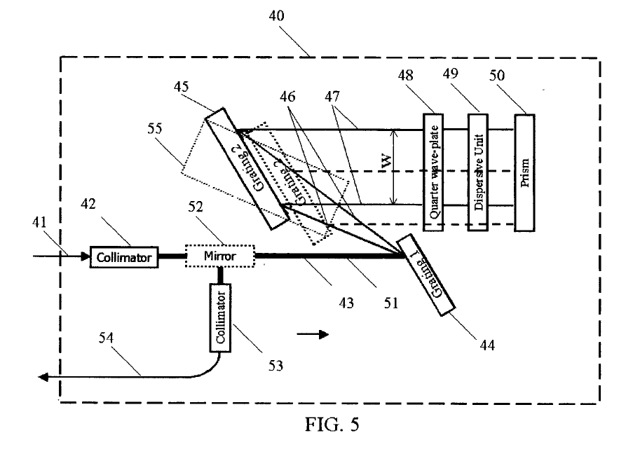

Referring now to FIG. 5, there is shown a block diagram of a tunable optical dispersion slope compensating arrangement 40 (shown within a dashed line rectangle) in accordance with a second embodiment of the present invention. There are three modifications compared to the first embodiment as described in FIG. 1. First, the end mirror in FIG. 1 is replaced by a 90-degree optical prism, which reflects the input optical beam towards 180 degree with respect to the input beam, and simultaneously shifts the beam in vertical direction. Note that FIG. 1 and FIG. 5 are top view of the block diagrams. Second, an optical mirror is placed in the returned path without blocking the input optical beam and re-directs the returned beam to the output port. Three, the circulator is not necessary in this arrangement, instead a second collimator is used to couple the return optical beam to the output fiber port.

The dispersion slope compensating arrangement 40 comprises an optical collimator 42, two optical gratings 44 and 45, a quarter-wave plate 48, a dispersive element 49, a 90-degree prism 50, an optical mirror 52 and a second collimator 53. The collimator 42 collimates the optical signal from an input optical fiber 41 to an optical beam 43 in free space, which is aligned to the first grating 44. Grating 44 and 45 are parallel to each other. The diffracted optical beam from grating 44 propagates towards to the second grating 45, which further diffracts the incoming beam 46 to an optical beam 47 that is parallel to beam 43. A quarter-wave plate 48, a dispersive element 49 and a 90-degree optical prism are serially placed in the path of beam 47. The 90-degree optical prism 50 is positioned in such a way that it reflects the input optical beam towards 180 degree with respect to the input beam, and simultaneously shifts the beam in vertical direction. The reflected beam propagates back passing through the element 49, 48, 45 and 44 parallel to the forward beam 47, 46 and 43. The reflected beam is vertically shifted with respect to the forward beams so that a properly placed mirror 52 can separate the return optical beam 51 from the forward beam, and re-directs it to a second collimator 53, which couples the optical beam to an output fiber 54. The second grating 45 is attached to an actuator or a translation stage 55 so that the grating can be moved while remaining parallel to the first grating 44.

The operation of the second embodiment is similar to the first embodiment described in FIG. 1 except the return path is different. The tuning mechanism is identical.

It is to be appreciated and understood that the specific embodiments of the invention described hereinabove are merely illustrative of the general principles of the invention. Various modifications may be made by those skilled in the art which are consistent with the principles set forth.

What I claim is:

1. An optical arrangement for providing tunable dispersion slope compensation to a received dispersion distorted input signal comprising n wavelength multiplexed channels, the arrangement comprising:
a pair of parallel diffractive gratings to separate each wavelength into parallel beam-let in space;
a spatially varying dispersive element with end surface coated with high reflection material, the dispersive element is properly aligned so that each wavelength beam-let will experience properly designed dispersion after passing through it;
a quarter-wave plate properly placed between the second grating and the dispersive element to eliminate polarization dependence of the optical arrangement;
a collimator is used to collimate the signal from the input fiber to a beam with proper beam width that is optimal for the gratings;
a circulator placed in between the input and the first grating to separate the reflected the signal and direct it to the output;
an actuator or a translation stage attached to the second grating to move the second grating so that the grating remains parallel to the first grating and the beam width of the diffracted beam from the second grating can be varied, resulting in tunable dispersion slope to the input optical signal;
a 90-degree prism placed after the dispersive element is used to move the beam up or down and reflect back at the same time so that the returning beam will be parallel to the input beam but shifted in height;
an optical mirror used to separate the returned optical beam from the input or forward optical beam, and re-directs the optical beam to an output optical collimator;
a second optical collimator used to coupled the returned optical beam to an output optical fiber.

2. The optical arrangement of claim 1 wherein the parallel gratings are arranged in such a way that the input beam is converted to a broader beam that is parallel to the input optical beam. Each wavelength, or channel is displaced in the second beam parallel to each other.

3. The optical arrangement of claim 1 wherein the quarter-wave plate is arranged so that the reflected beam will have its polarization rotated 90 degrees with respect to the input to the wave-plate. Therefore the polarization dependence of this optical arrangement will be eliminated.

4. The optical arrangement of claim 1 wherein the dispersive element provides varying dispersion across its width so that the space-displaced beam with different wavelengths will experience different dispersion values. The end surface of the dispersive element is coated with high reflection material so that the reflected beam will suffer little optical loss. The dispersive element is placed in such a way that the reflected optical beam from the end surface of the dispersive element propagates back exactly towards the incoming optical beam.

5. The optical arrangement of claim 1 wherein the dispersive element provides varying dispersion across its width so that the space-displaced beam with different wavelengths will experience different dispersion values. When the end surface of the dispersive element is not coated with high reflection material, an external mirror is placed after the dispersive element so that the reflected beam will propagates back exactly towards the incoming optical beam.

6. The optical arrangement of claim 1 wherein an actuator or translation stage is used to move the second optical grating so that the beam width of the diffracted optical beam from the second grating can be varied while keeping the second grating parallel to the first grating.

7. The optical arrangement of claim 1 wherein a collimator is used to collimate the signal from the input fiber to a beam with proper beam width that is optimal for the gratings.

8. The optical arrangement of claim 1 wherein a circulator is used to separate the reflected signal from the input signal and direct the reflected signal to a separate output port.

9. The optical arrangement of claim 1 further comprising a 90-degree prism placed after the dispersive element is used to move the beam up or down and reflect back at the same time so that the returning beam will be parallel to the input beam but shifted in height. A second coupling lens placed at proper height will couple the returned beam to the output port. No optical circulator is necessary.

10. The optical arrangement of claim 1 further comprising an optical mirror used to separate the returned optical beam from the input or forward optical beam, and re-directs the optical beam to an output optical collimator.

11. The optical arrangement of claim 1 further comprising a second optical collimator used to coupled the returned optical beam to an output optical fiber.
